(19) United States
(12) Patent Application Publication
(10) Pub. No.: US 2010/0136077 A1
(43) Pub. Date: Jun. 3, 2010

(54) BIOCIDIC HOUSEHOLD CLEANSING MATERIALS

(75) Inventors: Shmuel Bukshpan, Ramat Ha-Sharon (IL); Gleb Zilberstein, Rechovot (IL)

Correspondence Address: The Law Office of Michael E. Kondoudis, 888 16th Street, N.W., Suite 800, Washington, DC, 20006, US

(73) Assignee: OPLON B.V., Delft (NL)

(21) Appl. No.: 12/598,428

(22) PCT Filed: Apr. 3, 2008
(86) PCT No.: PCT/IL08/00464

§ 371 Date: Nov. 18, 2009

Related U.S. Application Data
(60) Provisional application No. 60/924,148, filed on May 1, 2007.

(51) Int. Cl. A01N 61/00; A01N 25/00; C08F 112/08

(52) U.S. Cl. 424/405; 526/319; 424/78.27; 424/78.31; 525/333.5; 526/346; 442/327; 442/1

(57) ABSTRACT

The present invention discloses household cleaning materials comprising at least one insoluble proton sink or source (PSS) and to method for utilizing the PSS as a biocidic agent. The household cleaning materials are provided useful for killing living target cells (LTCs) or otherwise inhibiting LTCs growth, disrupting vital intracellular processes and/or intercellular interactions of the LTC upon contact. The household cleaning materials consisting of at least one PSS, comprises, inter alia, (i) proton source or sink providing a buffering capacity; and (ii) means providing proton conductivity and/or electrical potential. The PSS is effectively disrupting the pH homeostasis and/or electrical balance within the confined volume of said LTC and/or disrupting vital intercellular interactions of said LTCs while efficiently preserving the pH of said LTCs' environment.

### FIELD OF THE INVENTION

The present invention pertains to household cleaning materials inhibiting microbial growth. More specifically, the invention relates to household cleaning materials that comprise means for killing living target cells, or otherwise disrupting vital intracellular processes and/or intercellular interactions of said cells upon contact.

### BACKGROUND OF THE INVENTION

The present invention relates to new compositions and materials exhibiting strong antimicrobial properties, for use in household cleaning in wipes, sprays, soaps, cleaning solutions, gels, creams, deodorants, fabric treatment materials etc.

Microorganisms like bacteria, fungi, molds etc. are ubiquitous in the human environment. The presence of these organisms can result in spoilage of food, detrimental environmental impact and in some cases, to direct infection.

Biofilm formation has widespread health implications. Any system that provides an interface between a surface and a fluid has the potential for biofilm development. For example, drinking water systems and water distribution conduits as well as water cooling towers for air conditioning systems are well-known to pose public health risks from biofilm formation, as episodic outbreaks of infections. Biofilms are also a constant problem in food processing and storage environments.

There exists, therefore, a need to be able to render general surfaces coming in contact with foods and humans in house environment bactericidal and a keen interest in materials capable of killing harmful microorganisms. Antimicrobial agents are incorporated into a wide variety of home products at an increasing rate.

Antimicrobial chemicals (biocides) include sterilants, disinfectants and fungicides. Biocides are generally synthetic or semi synthetic molecules that, above certain concentrations and under defined conditions will kill living cells within specified time intervals. Sterilants destroy all forms of microbial life; disinfectants eliminate infectious pathogenic bacteria; sanitizers reduce microbial contaminants; and fungicides destroy fungi on inanimate surfaces that are pathogenic to humans and animals.

Mechanical devices are sometimes used to control microorganisms in indoor air, including electronic air cleaners, ion generators, mechanical filters, pleated (e.g., high-efficiency particulate air) filters, activated charcoal impregnated filters, ozone generators, ultraviolet light and thermal mechanisms.

Impregnated devices include a wide variety of domestic products, such as clothes (e.g., undergarments, sporting garments and jeans), toys, kitchen utensils and a wide variety of plastic products. Additional products include antimicrobial window cleaners, antimicrobial chopsticks and bed clothing (e.g., pillows, sheets, towels and slippers).

The active ingredients in the above types of products vary from alcohols, peroxides and halides to antimicrobial chemicals, such as triclosan and quaternary ammonium compounds.

Alcohols Alcohol-based hand antiseptics contain isopropanol, ethanol or n-propanol, alone or in combination (4). Alcohols denature proteins, which are believed to be the main mechanism of antimicrobial action. Solutions containing 60% to 95% alcohol are most effective. The antimicrobial action of alcohols is transient but the effects may be prolonged by the addition of other chemicals such as chlorhexidine or triclosan. Alcohols have a wide spectrum of activity, but are less active against bacterial spores, some non-enveloped (non-lipophilic) viruses and protozoan oocysts. Alcohol-based hand rubs do have activity against several non-enveloped viruses (e.g., rotavirus, adenovirus, rhinovirus, hepatitis A and poliovirus). However, alcohol may not be effective against hepatitis A and other non-lipophilic viruses, depending on the alcohol concentration and the amount of time that viruses are exposed to the alcohol.

Chlorhexidine Chlorhexidine gluconate is a cationic bisbiguanide (4). The mechanism of action is believed to be the disruption of cytoplasmic membranes with subsequent precipitation of cellular material. Chlorhexidine gluconate is active against Gram-positive bacteria, is less active against Gram-negative bacteria and fungi, and only exhibits minimal activity against Mycobacterium tuberculosis. It is not sporicidal and has in vitro activity against enveloped viruses (e.g., herpes simplex virus, HIV, cytomegalovirus, influenza and respiratory syncytial virus), but has less activity against nonenveloped viruses (e.g., rotavirus, adenovirus and enteroviruses). Chlorhexidine gluconate is included in a number of hand hygiene preparations and antiseptic detergent preparations.

Triclosan Triclosan is a nonionic substance that has been incorporated into soaps and other consumer products (4). Concentrations of 0.2% to 2% have antimicrobial activity. Triclosan enters bacterial cells and affects the cytoplasmic membrane and synthesis of RNA, fatty acids and proteins. It has a broad range of antimicrobial activity. It is often bacteriostatic. Triclosan's activity against Gram-positive organisms is greater than against Gram-negative bacilli. The agent possesses reasonable activity against mycobacteria and Candida species, but it has limited activity against filamentous fungi. Like chlorhexidine, the activity of triclosan on the skin is more persistent than that of alcohol.

Quaternary ammonium compounds The antimicrobial activity of quaternary ammonium compounds is likely attributable to their adsorption onto the cytoplasmic membrane, with subsequent leakage of low molecular weight cytoplasmic components (4). Quaternary ammonium compounds are mainly bacteriostatic and fungistatic, although they are microbicidal against certain organisms at high concentrations. They are more active against Gram-positive bacteria than against Gram-negative bacilli. These compounds are active against lipophilic viruses, but they are less active against mycobacteria and fungi. Among these compounds, benzalkonium chlorides are the most frequently used.

Other compounds There are several antimicrobial agents that may be used alone or in combination. Some of these, such as chlorine-based and iodine-based products, are well established as being very useful in specific situations (e.g., dilute bleach is recommended for cleaning up spillage of body fluids). Chloroxylenol (parachlorometaxylenol or PCMX) is used as a preservative in cosmetics and other products, and is also used in antimicrobial soaps Silver and silver ions have proven antimicrobial activity and can be incorporated in products.

Facial tissue impregnated with an antiviral agent has been promoted. The first of these tissues to be commercially available is Kleenex™ (Kimberly-Clark, USA) (5). The tissue has three layers, with a moisture-activated middle layer. This layer contains citric acid and sodium lauryl sulfate, which are active against Rhinoviruses and several enveloped viruses, respectively. The product is virucidal in vitro against rhinoviruses type 1A and type 2, influenza A and influenza B, and respiratory syncytial virus. However, virus that is transferred from nose to tissue without passing through the active layer is still infectious. It has not been established whether this product can reduce transmission of respiratory infections in households. It has been suggested that frequent handwashing may be more effective.

These materials when used in home environment are required not to affect the taste, texture or aesthetics of the product or have any harmful effects. Most of the above listed antimicrobial agents are gradually released into the surrounding solution over time and kill deleterious cells and microorganisms there (Medlin, J. (1997) Environ. Health Preps. 105,290-292; Nohr, R. S. & Macdonald, G. J. (1994) J. Biomater. Sci., Polymer Edn. 5,607-619 Shearer, A. E. H., et al (2000) Biotechnol. Bioeng 67,141-146.). Although these strategies have been verified in aqueous solutions containing bacteria, they would not be expected to be effective against airborne bacteria in the absence of a liquid medium; this is especially true for release-based materials, which are also liable to become impotent when the leaching antibacterial agent is exhausted.

Various additives and polymer systems have been suggested as providing antimicrobial properties. See, for example, U.S. Pat. No. 3,872,128 to Byck, U.S. Pat. No. 5,024,840 to Blakely et al, U.S. Pat. No. 5,290,894 to Malrose et al, U.S. Pat. Nos. 5,967,714, 6,203,856 and U.S. Pat. No. 6,248,811 to Ottersbach et al, U.S. Pat. No. 6,194,530 to Klasse et al. and U.S. Pat. No. 6,242,526 to Siddiqui et al.

However, there is also a need for such agents to be both sustainable and to be compatible, and to be used on and with a wide variety of polymer materials and substrates.

### SUMMARY OF THE INVENTION

It is one object of the invention to disclose household cleaning materials, comprising at least one insoluble proton sink or source (PSS). The household cleaning materials are provided useful for killing living target cells (LTCs), or otherwise disrupting vital intracellular processes and/or intercellular interactions of the LTC upon contact. The PSS comprising (i) proton source or sink providing a buffering capacity; and (ii) means providing proton conductivity and/or electrical potential; wherein the PSS is effectively disrupting the pH homeostsis and/or electrical balance within the confined volume of the LTC and/or disrupting vital intercellular interactions of the LTCs while efficiently preserving the pH of the LTCs' environment.

It is in the scope of the invention wherein the PSS is an insoluble hydrophobic, anionic, cationic or zwitterionic charged polymer, useful for killing living target cells (LTCs), or otherwise disrupting vital intracellular processes and/or intercellular interactions of the LTC upon contact. It is additionally or alternatively in the scope of the invention, wherein the PSS is an insoluble hydrophilic, anionic, cationic or zwitterionic charged polymer, combined with water-immiscible polymers useful for killing living target cells (LTCs), or otherwise disrupting vital intracellular processes and/or intercellular interactions of the LTC upon contact. It is further in the scope of the invention, wherein the PSS is an insoluble hydrophilic, either anionic, cationic or zwitterionic charged polymer, combined with water-immiscible either anionic, cationic of zwitterionic charged polymer useful for killing living target cells (LTCs), or otherwise disrupting vital intracellular processes and/or intercellular interactions of the LTC upon contact.

It is also in the scope of the invention wherein the PSS is adapted in a non-limiting manner, to contact the living target cell either in a bulk or in a surface; e.g., at the outermost boundaries of an organism or inanimate object that are capable of being contacted by the PSS of the present invention; at the inner membranes and surfaces of microorganisms, animals and plants, capable of being contacted by the PSS by any of a number of transdermal delivery routes etc; at the bulk, either a bulk provisioned with stirring or not etc.

It is further in the scope of the invention wherein either (i) a PSS or (ii) the household cleaning materials comprising the PSS, also comprises an effective measure of at least one additive.

It is another object of the invention to disclose the household cleaning materials as defined above, wherein the proton conductivity is provided by water permeability and/or by wetting, especially wherein the wetting is provided by hydrophilic additives.

It is another object of the invention to disclose the household cleaning materials as defined above, wherein the proton conductivity or wetting is provided by inherently proton conductive materials (IPCMs) and/or inherently hydrophilic polymers (IHPs), especially by IPCMs and/or IHPs selected from a group consisting of sulfonated tetrafluortheylene copolymers; sulfonated materials selected from a group consisting of silica, polythion-ether sulfone (SPTES), styrene-ethylene-butylene-styrene (S-SEBS), polyether-ether-ketone (PEEK), poly (arylene-ether-sulfone) (PSU), Polyvinylidene Fluoride (PVDF)-grafted styrene, polybenzimidazole (PBI) and polyphosphazene; proton-exchange membrane made by casting a polystyrene sulfonate (PSSnate) solution with suspended micron-sized particles of cross-linked PSSnate ion exchange resin; commercially available Nafion™ and derivatives thereof.

It is another object of the invention to disclose the household cleaning materials as defined above, wherein the device comprising two or more, either two-dimensional (2D) or three-dimensional (3D) PSSs, each of which of the PSSs consisting of materials containing highly dissociating cationic and/or anionic groups (HDCAs) spatially organized in a manner which efficiently minimizes the change of the pH of the LTC's environment; each of the HDCAs is optionally spatially organized in specific either 2D, topologically folded 2D surfaces, or 3D manner efficiently which minimizes the change of the pH of the LTC's environment; further optionally, at least a portion of the spatially organized HDCAs are either 2D or 3D positioned in a manner selected from a group consisting of (i) interlacing; (ii) overlapping; (iii) conjugating; (iv) either homogeneously or heterogeneously mixing and (iv) tiling the same

It is another object of the invention to disclose the household cleaning materials as defined above, wherein the PSS is effectively disrupting the pH homeostasis within a confined volume while efficiently preserving the entirety of the LTC's environment; and further wherein the environment's entirety is characterized by parameters selected from a group consisting of the environment functionality, chemistry; soluble's concentration, possibly other then proton or hydroxyl concentration; biological related parameters; ecological related parameters; physical parameters, especially particles size distribution, rehology and consistency; safety parameters, especially toxicity, otherwise LD₅₀ or ICT₅₀ affecting parameters; olphactory or organoleptic parameters (e.g., color, taste, smell, texture, conceptual appearance etc); or any combination of the same.

It is another object of the invention to disclose the household cleaning materials as defined above, wherein the device is provided useful for disrupting vital intracellular processes and/or intercellular interactions of the LTC, while both (i) effectively preserving the pH of the LTC's environment, and (ii) minimally affecting the entirety of the LTC's environment such that a leaching from the PSS of either ionized or electrically neutral atoms, molecules or particles (AMP) to the LTC's environment is minimized.

It is well in the scope of the invention wherein the aforesaid leaching minimized such that the concentration of leached ionized or neutral atoms is less than 1 ppm. Alternatively, the aforesaid leaching is minimized such that the concentration of leached ionized or neutral atoms is less than less than 50 ppb. Alternatively, the aforesaid leaching is minimized such that the concentration of leached ionized or neutral atoms is less than less than 50 ppb and more than 10 ppb. Alternatively, the aforesaid leaching is minimized such that the concentration of leached ionized or neutral atoms is less than less than 10 but more than 0.5 ppb. Alternatively, the aforesaid leaching is minimized such that the concentration of leached ionized or neutral atoms is less than less than 0.5 ppb.

It is another object of the invention to disclose the household cleaning materials as defined above, wherein the device is provided useful for disrupting vital intracellular processes and/or intercellular interactions of the LTC, while less disrupting pH homeostasis and/or electrical balance within at least one second confined volume (e.g., non-target cells, NTC).

It is another object of the invention to disclose the household cleaning materials as defined above, wherein the differentiation between the LTC and NTC is obtained by one or more of the following means (i) providing differential ion capacity; (ii) providing differential pH values; and, (iii) optimizing PSS to target cell size ratio; (iv) providing a differential spatial, either 2D, topologically folded 2D surfaces, or 3D configuration of the PSS; (v) providing a critical number of PSS' particles (or applicable surface) with a defined capacity per a given volume; and (vi) providing size exclusion means.

It is another object of the invention to disclose the household cleaning materials as defined above, comprising at least one insoluble non-leaching PSS as defined in any of the above, wherein the PSS, located on the internal and/or external surface of the household cleaning materials, is provided useful, upon contact, for disrupting pH homeostasis and/or electrical balance within at least a portion of an LTC while effectively preserving pH & functionality of the surface.

It is another object of the invention to disclose the household cleaning materials as defined above, wherein the household cleaning materials are provided useful for target cell's killing, the method is having at least one external proton-permeable surface with a given functionality, the surface is at least partially composed of, or topically and/or underneath layered with a PSS, such disruption of vital intracellular processes and/or intercellular interactions of the LTC is provided, while the LTC's environment's pH & the functionality is effectively preserved.

It is another object of the invention to disclose the household cleaning materials as defined above, the household cleaning materials further comprising a surface with a given functionality, and one or more external proton-permeable layers, each of which of the layers is disposed on at least a portion of the surface; wherein the layer is at least partially composed of or layered with a PSS such that vital intracellular processes and/or intercellular interactions of the LTC are disrupted, while the LTC's environment's pH & the functionality is effectively preserved.

It is another object of the invention to disclose the household cleaning materials as defined above, the device further comprising (i) at least one PSS; and (ii) one or more preventive barriers, providing the PSS with a sustained long activity; preferably wherein at least one barrier is a polymeric preventive barrier adapted to avoid heavy ion diffusion; further preferably wherein the polymer is an ionomeric barrier, and particularly a commercially available Nafion™.

It is hence in the scope of the invention wherein one or more of the following materials are provided: encapsulated strong acidic and strong basic buffers in solid or semi-solid envelopes, solid ion-exchangers (SIEx), ionomers, coated-SIEx, high-cross-linked small-pores SIEx, Filled-pores SIEx, matrix-embedded SIEx, ionomeric particles embedded in matrices, mixture of anionic (acidic) and cationic (basic) SIEx etc.

It is another object of the invention to disclose the PSS as defined in any of the above, wherein the PSS are naturally occurring organic acids compositions containing a variety of carbocsylic and/or sulfonic acid groups of the family, abietic acid (C₂₀H₃₀O₂) such as colophony/rosin, pine resin and alike, acidic and basic terpenes.

It is another object of the invention to disclose the household cleaning materials as defined above, the device further adapted to avoid development of LTC's resistance and selection over resistant mutations.

It is another object of the invention to disclose the household cleaning materials as defined above, wherein the device further comprising designed as a continuous barrier the barrier is selected from a group consisting of either 2D or 3D pads, sponges, nonwoven webs, membranes, filters, meshes, nets, sheet-like members, particulate matter or any combination thereof.

It is another object of the invention to disclose the household cleaning materials as defined above, wherein the device further designed as an insert, comprising at least one PSS, the insert is provided with dimensions adapted to ensure either (i) reversibly mounting or (ii) permanent accommodation of the insert within a predetermined article of manufacture.

It is another object of the invention to disclose the household cleaning materials as defined above, wherein the device further characterized by at least one of the following (i) regeneratable proton source or sink; (ii) regeneratable buffering capacity; and (iii) regeneratable proton conductivity.

It is another object of the invention to disclose a method for killing living target cells (LTCs), or otherwise disrupting vital intracellular processes and/or intercellular interactions of the LTC being in contact with household cleaning materials. The method comprising steps of providing the household cleaning materials with at least one PSS having (i) proton source or sink providing a buffering capacity; and (ii) means providing proton conductivity and/or electrical potential; contacting the LTCs with the PSS; and, by means of the PSS, effectively disrupting the pH homeostasis and/or electrical balance within the LTC while efficiently preserving the pH of the LTC's environment.

It is another object of the invention to disclose a method as defined above, wherein the step (a) further comprising a step of providing the PSS with water permeability and/or wetting characteristics, in particular wherein the proton conductivity and wetting is at least partially obtained by providing the PSS with hydrophilic additives.

It is another object of the invention to disclose a method as defined above, the method further comprising a step of providing the PSS with inherently proton conductive materials (IPCMs) and/or inherently hydrophilic polymers (IHPs), especially by IPCMs and/or IHPs selected from a group consisting of sulfonated tetrafluortheylene copolymers; sulfonated materials selected from a group consisting of silica, polythion-ether sulfone (SPTES), styrene-ethylene-butylene-styrene (S-SEBS), polyether-ether-ketone (PEEK), poly (arylene-ether-sulfone) (PSU), Polyvinylidene Fluoride (PVDF)-grafted styrene, polybenzimidazole (PBI) and polyphosphazene; proton-exchange membrane made by casting a polystyrene sulfonate (PSSnate) solution with suspended micron-sized particles of cross-linked PSSnate ion exchange resin; commercially available Nafion™ and derivatives thereof.

It is another object of the invention to disclose a method as defined above, the method further comprising steps of providing the household cleaning materials with two or more, either two-dimensional (2D) or three-dimensional (3D) PSSs, each of which of the PSSs consisting of materials containing highly dissociating cationic and/or anionic groups (HDCAs); and, spatially organizing the HDCAs in a manner which minimizes the change of the pH of the LTC's environment.

It is another object of the invention to disclose a method as defined above, the method further comprising a step of spatially organizing each of the HDCAs in a specific, either 2D or 3D manner, such that the change of the pH of the LTC's environment is minimized.

It is another object of the invention to disclose a method as defined above, wherein the step of organizing is provided by a manner selected for a group consisting of (i) interlacing the HDCAs; (ii) overlapping the HDCAs; (iii) conjugating the HDCAs; and (iv) either homogeneously or heterogeneously mixing the HDCAs.

It is another object of the invention to disclose a method as defined above, the method further comprising a step of disrupting pH homeostasis and/or electrical potential within at least a portion of an LTC by a PSS, while both (i) effectively preserving the pH of the LTC's environment; and (ii) minimally affecting the entirety of the LTC's environment; the method is especially provided by minimizing the leaching of either ionized or electrically neutral atoms, molecules or particles from the PSS to the environment.

It is another object of the invention to disclose a method as defined above, the method further comprising steps of preferentially disrupting pH homeostasis and/or electrical balance within at least one first confined volume (e.g., target living cells, LTC), while less disrupting pH homeostasis within at least one second confined volume (e.g., non-target cells, NTC).

It is another object of the invention to disclose a method as defined above, wherein the differentiation between the LTC and NTC is obtained by one or more of the following steps: (i) providing differential ion capacity; (ii) providing differential pH value; (iii) optimizing the PSS to LTC size ratio; and, (iv) designing a differential spatial configuration of the PSS boundaries on top of the PSS bulk; and (v) providing a critical number of PSS' particles (or applicable surface) with a defined capacity per a given volume.

It is another object of the invention to disclose a method for the production of a household cleaning materials, comprising steps of providing household cleaning materials as defined in any of the above; comprising steps of locating the PSS on top or underneath the surface of the household cleaning materials; and upon contacting the PSS with a LTC, disrupting the pH homeostasis and/or electrical balance within at least a portion of the LTC while effectively preserving pH & functionality of the surface.

It is another object of the invention to disclose a method as defined above, the method further comprising steps of: providing the household cleaning materials with at least one external proton-permeable surface with a given functionality; and, providing at least a portion of the surface with at least one PSS, and/or layering at least one PSS on top of underneath the surface; hence killing LTCs or otherwise disrupting vital intracellular processes and/or intercellular interactions of the LTC, while effectively preserving the LTC's environment's pH & functionality.

It is another object of the invention to disclose a method as defined above, the method further comprising steps of: providing the household cleaning materials with at least one external proton-permeable providing a surface with a given functionality; disposing one or more external proton-permeable layers topically and/or underneath at least a portion of the surface; the one or more layers are at least partially composed of or layered with at least one PSS; and, killing LTCs, or otherwise disrupting vital intracellular processes and/or intercellular interactions of the LTC, while effectively preserving the LTC's environment's pH & functionality.

It is another object of the invention to disclose a method as defined above, the method further comprising steps of providing the household cleaning materials with at least one PSS; and, providing the PSS with at least one preventive barrier such that a sustained long acting is obtained.

It is in the scope of the invention, wherein the proton and/or hydroxyl-exchange between the cell and strong acids and/or strong basic materials and compositions may lead to disruption of the cell pH-homeostasis and consequently to cell death. The proton conductivity property, the volume buffer capacity and the bulk activity are pivotal and crucial to the present invention.

It is another object of the invention to disclose a method as defined above, wherein the step of providing the barrier is obtained by utilizing a polymeric preventive barrier adapted to avoid heavy ion diffusion; preferably by providing the polymer as an ionomeric barrier, and particularly by utilizing a commercially available Nafion™ product.

It is another object of the invention to disclose a method for inducing apoptosis in at least a portion of LTCs population in household cleaning materials. The method comprising steps of: obtaining at least one household cleaning materials as defined in any of eth above; contacting the PSS with an LTC; and, effectively disrupting the pH homeostasis and/or electrical balance within the LTC such that the LTC's apoptosis is obtained, while efficiently preserving the pH of the LTC's environment and patient's safety.

It is another object of the invention to disclose a method for avoiding development of LTC's resistance and selecting over resistant mutations. The method comprising steps of: obtaining at least one household cleaning materials as defined in any of the above; contacting the PSS with an LTC; and, effectively disrupting the pH homeostasis and/or electrical balance within the LTC such that development of LTC's resistance and selecting over resistant mutations is avoided, while efficiently preserving the pH of the LTC's environment and patient's safety.

It is another object of the invention to disclose a method of regenerating the biocidic properties of household cleaning materials as defined in any of the above; comprising at least one step selected from a group consisting of (i) regenerating the PSS; (ii) regenerating its buffering capacity; and (iii) regenerating its proton conductivity.

It is in the scope of the invention wherein an effective dose of the PSS is soaked, doped, immersed, contained, immobilized or otherwise bonded to the either inner or outer surface of the household cleaning materials.

It is in the scope of the invention wherein the household cleaning materials are selected in a non limiting manner form articles of manufacture selected in a non-limiting manner form a group consisting of soaps; soaps with cleaning substrates, such as pads, nonwoven webs or sponges; antibacterial laundry additives; laundry detergents; antibacterial wipes; antibacterial spray; pre-moistened wipes; conditioners; softeners; shampoos etc

### BRIEF DESCRIPTION OF THE DRAWINGS

In order to understand the invention and to see how it may be implemented in practice, a plurality of preferred embodiments will now be described, by way of non-limiting example only, with reference to the accompanying drawing, in which

FIG. 1 is illustrating the bacterial counts in fabric samples taken from regular softener treated laundry and modified softener treated laundry;

FIG. 2 is presenting bacterial counts (CFU) in cloth samples 0.5 and 24 hrs after boil-wash with or without antibacterial laundry additive;

FIG. 3 is presenting bacterial counts (CFU) in cloth samples 0.5, 24, 48 hrs and 9 days after boil-wash with or without antibacterial laundry additive;

FIG. 4 is showing bacterial counts (CFU) in samples taken from sprayed and unsprayed marble surface;

FIG. 5 is showing bacterial counts (CFU) in samples taken from Comp 1-sprayed and unsprayed carpet; and,

FIG. 6 is showing the activity of commercially available laundry softener (Badin™) as compared a composition comprising PSS according to the present invention (i.e., Bioactivity™ laundry additive)

### DESCRIPTION OF THE PREFERRED EMBODIMENTS

The following specification taken in conjunction with the drawings sets forth the preferred embodiments of the present invention. The embodiments of the invention disclosed herein are the best modes contemplated by the inventors for carrying out their invention in a commercial environment, although it should be understood that various modifications can be accomplished within the parameters of the present invention.

The term ‘contact’ refers hereinafter to any direct or indirect contact of a PSS with a confined volume (living target cell or virus—LTC), wherein said PSS and LTC are located adjacently, e.g., wherein the PSS approaches either the internal or external portions of the LTC; further wherein said PSS and said LTC are within a proximity which enables (i) an effective disruption of the pH homeostasis and/or electrical balance, or (ii) otherwise disrupting vital intracellular processes and/or intercellular interactions of said LTC.

The terms ‘effectively’ and ‘effectively’ refer hereinafter to an effectiveness of over 10%, additionally or alternatively, the term refers to an effectiveness of over 50%; additionally or alternatively, the term refers to an effectiveness of over 80%. It is in the scope of the invention, wherein for purposes of killing LTCs, the term refers to killing of more than 50% of the LTC population in a predetermined time, e.g., 10 min.

The term ‘additives’ refers hereinafter to one or more members of a group consisting of biocides e.g., organic biocides such as tea tree oil, rosin, abietic acid, terpens, rosemary oil etc, and inorganic biocides, such as zinc oxides, cupper and mercury, silver salts etc, markers, biomarkers, dyes, pigments, radio-labeled materials, glues, adhesives, lubricants, medicaments, sustained release drugs, nutrients, peptides, amino acids, polysaccharides, enzymes, hormones, chelators, multivalent ions, emulsifying or de-emulsifying agents, binders, fillers, thickfiers, factors, co-factors, enzymatic-inhibitors, organoleptic agents, carrying means, such as liposomes, multilayered vesicles or other vesicles, magnetic or paramagnetic materials, ferromagnetic and non-ferromagnetic materials, biocompatibility-enhancing materials and/or biodegradating materials, such as polylactic acids and polyglutaminc acids, anticorrosive pigments, anti-fouling pigments, UV absorbers, UV enhancers, blood coagulators, inhibitors of blood coagulation, e.g., heparin and the like, or any combination thereof.

The term ‘particulate matter’ refers hereinafter to one or more members of a group consisting of nano-powders, micrometer-scale powders, fine powders, free-flowing powders, dusts, aggregates, particles having an average diameter ranging from about 1 nm to about 1000 nm, or from about 1 mm to about 25 mm.

The term ‘about’ refers hereinafter to ±20% of the defined measure.

The term ‘soap’ refers hereinafter in a non-limiting manner to the popular sense of the term, i.e., alkalimetal or alkanol ammonium salt of aliphatic alkane or alkene monocarboxylic acids. Sodium, potassium, mono-, di- and triethanol ammonium cations, or combinations thereof, are suitable for purposes of the invention. Generally, sodium soaps are used. Soaps useful herein are the well known alkali metal salts of natural or synthetic aliphatic (alkanoic or alkenoic) acids having 13 to 22 cations, preferably 12 to 18. They may be described as alkali metal carboxylates of acrylic hydrocarbons having about 12 to 22 carbons. The term also refers to detergents and surfactants i.e., materials which preferably orient toward an interface, classes of surfactants including nonionic surfactants, anionic surfactants, cationic surfactants, amphoteric surfactants, zwitterionic surfactants, and mixtures thereof The soaps are possibly utilized, various locations and for various purposes. Hence for example and ina non-limiting manner, it is utilizes in swimming pools, spas, etc., as a laundry soap or detergent additive, as a paint or surface coating additive, as a natural or synthetic surface preservative such as the prevention of microfloral growth on surfaces such as polymers, plastics or wood, as a hard surface or carpet sanitizer. The soap as defined hereinafter, is generally useful in controlling and/or elimination of microflora and spores in many industrial, medical, agricultural, veterinary and domestic applications. Additionally, the soap can be employed to sterilize or disinfect gaseous environments including, for example, the cleansing of the atmosphere in homes and industrial sites, as well as airplanes, etc.

The term ‘surface’ refers hereinafter in its broadest sense. In one sense, the term refers to the outermost boundaries of an organism or inanimate object (e.g., vehicles, buildings, and food processing equipment, etc.) that are capable of being contacted by the compositions of the present invention (e.g., for animals: the skin, hair, and fur, etc., and for plants: the leaves, stems, flowering parts, and fruiting bodies, etc.). In another sense, the term also refers to the inner membranes and surfaces of animals and plants (e.g., for animals: the digestive tract, vascular tissues, and the like, and for plants: the vascular tissues, etc.) capable of being contacted by compositions by any of a number of transdermal delivery routes (e.g., injection, ingestion, transdermal delivery, inhalation, and the like).

The term ‘Household cleaning materials’ refers hereinafter in a non-limiting manner to soaps used with cleaning substrates, such as pads, nonwoven webs or sponges and/or particulate matter for cleansing. It is further in the scope of the invention wherein the term ‘household cleaning materials’ also relates to articles of manufacture selected in a non-limiting manner form a group consisting of soaps; soaps with cleaning substrates, such as pads, non-woven webs or sponges; antibacterial laundry additives; laundry detergents; antibacterial wipes; antibacterial spray; toilet cleansers; pre-moistened wipes; conditioners; softeners; shampoos etc

The term “pre-moistened wipe” refers hereinafter to a wipe which includes a substrate which is moistened, such as by wetting the substrate with a liquid composition, prior to use by the consumer. The term also refers to wipes having a substrate which is moistened prior to packaging, such as in a generally moisture impervious container or wrapper.

The present invention relates to compositions and methods for killing cells based on the generation of cellular pH gradients (titration) leading to the disruption of cellular homeostasis thereof with solid buffers and the like: solid ion-exchangers (SIEx), ionomers, coated-SIEx, high-cross-linked small-pores SIEx, Filled-pores SIEx, matrix-embedded SIEx, Ionomeric particles embedded in matrices, mixture of anionic and cationic SIEx etc. These new compositions exert their cell killing effect via preferential proton-exchange between the said cell and the cytotoxic (solid medium) (ion exchanger). The principal properties of these materials are proton conductivity, capacity to preserve or regenerate proton or hydroxyl concentration (buffer capacity) and all these through the volume of the matrix (bulk activity).

Examples of household products exhibiting antibacterial properties based on materials of invention:

(a) Antibacterial laundry additive compatible with quaternary amine-based softeners.Exemplary Formulation: Amberlite™ CG-400-II beads (Rohm and Haas, OH⁻ form) 50 g per 5 L of washing water; 10 g polyvinyl alcohol; Preparation: Amberlite™ powder (size ˜10 micron) are mixed with polyvinyl alcohol water solution.

(b) Laundry additives compatible with laundry detergent (soap/SDS—stage): propyl sulfonic acid bonded silica gel beads, size of about 1 μm, H⁺ form, 10%; water; ethanol 10%; polyvinyl alcohol 7%; Polysterensulfonic acid water based solution 18% (SIGMA); K1 powder, 20 μm, ion exchange particles of polypropylene polystyrene-divinilbenzene with SO₃H as the functional group; Co-production of IFOCH, Nat. Acad. Of Science, Belarus and Unitechprom BSU; Amberlite™ IR-120 II powder Rohm and Haas, 20 μm size;

(c) Antibacterial wipe: Cloth exhibiting antibacterial activity used to wipe household surface;non-woven cloth made of fibers of Formulation K1 (H+ form)—Fiban K1; Non-woven cloth made of fibers (Formulation A1). Material FIBAN—A1OH⁺ form) as K1 but with CH₂N(CH₃) as the functional group; Formulation: Amberlite™ CG-400-II (OH⁺ form) beads attached to cotton cloth by hot treatment (ironing);

(d) Antibacterial spray: Exemplary formulation of antibacterial spray were prepared as follows (i) Formulation: Propyl Sulfonic Acid Bonded Silica Gel beads (size ˜1 mkm) (H⁺ form) 10%; water; ethanol 10%; polyvinyl alcohol 7%; (Comp.1); (ii) Formulation: Polysterensulfonic acid water based solution 18% (SIGMA); (Comp.2); (iii) Formulation: Amberlite™ CG-400-II (OH⁻ form) 10% in 7% polyvinyl alcohol water based solution; (Comp.3); (iv) Formulation: Amberlite™ CG-400-II (OH⁻ form) 10% in 7% polyvinyl alcohol water based solution; quaternary amines 5%; (Comp.4);

(e) pre-moistened wipes; (f) soaps; and (g) conditioners, softeners etc.

It is in the scope of the invention, wherein household cleaning materials comprising an insoluble PSS in the form of a polymer, ceramic, gel, resin or metal oxide is disclosed. The PSS is carrying strongly acidic or strongly basic functional groups (or both) adjusted to a pH of about <4.5 or about >8.0. It is in the scope of the invention, wherein the insoluble PSS is a solid buffer.

It is also in the scope of the invention wherein material's composition is provided such that the groups are accessible to water whether they are on the surface or in the interior of the PSS. Contacting a living cell (e.g., bacteria, fungi, animal or plant cell) with the PSS kills the cell in a time period and with an effectiveness depending on the pH of the PSS, the mass of PSS contacting the cell, the specific functional group(s) carried by the PSS, and the cell type. The cell is killed by a titration process where the PSS causes a pH change within the cell. The cell is often effectively killed before membrane disruption or cell lysis occurs. The PSS kills cells without directly contacting the cells if contact is made through a coating or membrane which is permeable to water, H+and OH− ions, but not other ions or molecules. Such a coating also serves to prevent changing the pH of the PSS or of the solution surrounding the target cell by diffusion of counterions to the PSS's functional groups. It is acknowledged in thos respect that prior art discloses cell killing by strongly cationic (basic) molecules or polymers where killing probably occurs by membrane disruption and requires contact with the strongly cationic material or insertion of at least part of the material into the outer cell membrane.

It is also in the scope of the invention wherein an insoluble polymer, ceramic, gel, resin or metal oxide carrying strongly acid (e.g. sulfonic acid or phosphoric acid) or strongly basic (e.g. quaternary or tertiary amines) functional groups (or both) of a pH of about <4.5 or about >8.0 is disclosed. The functional groups throughout the PSS are accessible to water, with a volumetric buffering capacity of about 20 to about 100 mM H⁺/pH unit, which gives a neutral pH when placed in unbuffered water (e.g., about 5 <pH> about 7.5) but which kills living cells upon contact.

It is also in the scope of the invention wherein the insoluble polymer, ceramic, gel, resin or metal oxide as defined above is coated with a barrier layer permeable to water, H⁺ and OH⁻ ions, but not to larger ions or molecules, which kills living cells upon contact with the barrier layer.

It is also in the scope of the invention wherein the insoluble polymer, ceramic, gel, resin or metal oxide as defined above is provided useful for killing living cells by inducing a pH change in the cells upon contact.

It is also in the scope of the invention wherein the insoluble polymer, ceramic, gel, resin or metal oxide as defined above is provided useful for killing living cells without necessarily inserting any of its structure into or binding to the cell membrane.

It is also in the scope of the invention wherein the insoluble polymer, ceramic, gel, resin or metal oxide as defined above is provided useful for killing living cells without necessarily prior disruption of the cell membrane and lysis.

It is also in the scope of the invention wherein the insoluble polymer, ceramic, gel, resin or metal oxide as defined above is provided useful for causing a change of about <0.2 pH units of a physiological solution or body fluid surrounding a living cell while killing the living cell upon contact.

It is also in the scope of the invention wherein the insoluble polymer, ceramic, gel, resin or metal oxide as defined above is provided in the form of shapes, a coating, a film, sheets, beads, particles, microparticles or nanoparticles, fibers, threads, powders and a suspension of these particles.

### Example 1

Antibacterial Laundry Softener

Material and methods A regular household laundry session at home (30° C.) performed with modified softener as described above and tested against standard softener by recording bacterial growth of natural flora by placing samples of wet fabrics on agar plates, at the various intervals. Laundry was kept wet in the washing machine, at room temperature, until sampled.

Results

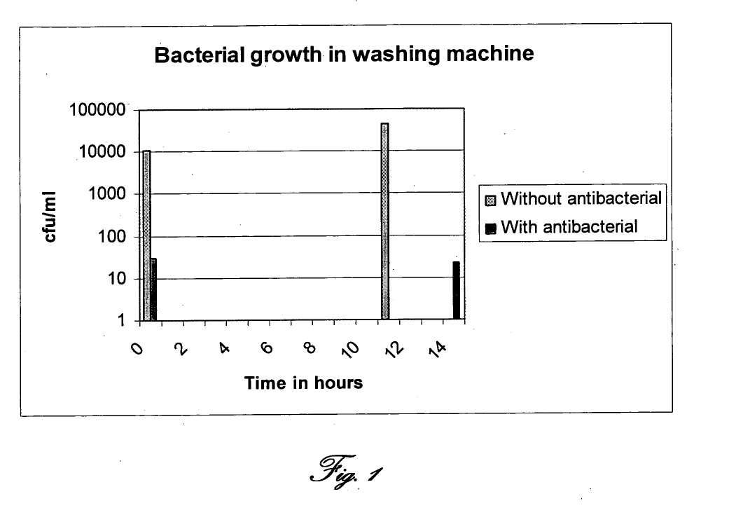

Reference is made to FIG. 1, illustrating the bacterial counts in fabric samples taken from regular softener treated laundry and modified softener treated laundry.

The results are presented in FIG. 1 showing 3-orders of magnitude decrease in bacterial count at time zero (right after the laundry session) and 12 hours thereafter between regular softener treated laundry and modified softener.

### Example 2

Antibacterial Laundry Additives

Material and Methods

Tow pieces of cotton (sample 1 & 2) were boil-washed with standard household detergents.

Following the washing stage, 50 milliliters of the spray formulations of Comp.4 above were added in the final rinse stage. Two other pieces of cotton (sample 3 & 4) were boil-washed in a standard manner and served as controls. 30 min after the wash the samples were tested for natural bacterial flora as described above. Following that test the samples were kept in open air in a very contaminated room for several days and sampled periodically.

Results

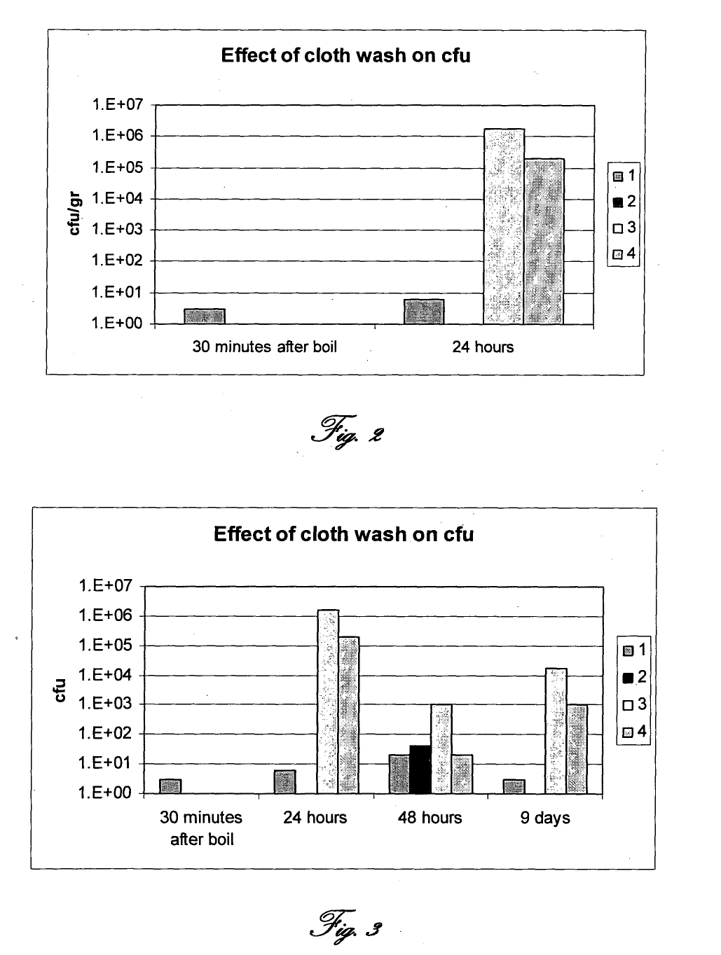

Reference in now made to FIG. 2, presenting bacterial counts (CFU) in cloth samples 0.5 and 24 hrs after boil-wash with or without antibacterial laundry additive; and to FIG. 3, presenting bacterial counts (CFU) in cloth, samples 0.5, 24, 48 hrs and 9 days after boil-wash with or without antibacterial laundry additive.

The results are summarized in the following Table 1 and FIGS. 2 & 3 showing a strong inhibition of bacterial growth in the samples 1 and 2 up to 9 days As compared with the control samples.

TABLE 1
Bacterial counts (CFU) in cloth samples after boil-wash
with or without antibacterial laundry additive

| Sample # | 1 | 2 | 3 | 4 |
|---|---|---|---|---|
| 0.5 hrs after boil | 3 | 0 | 0 | 1 |
| 24 hrs | 6 | 0 | 1.7 × 10⁶ | 2.0 × 10⁵ |
| 48 hrs | 20 | 40 | 1.0 × 10³ | 20 |
| 9 days | 3 | 1 | 1.7 × 10⁴ | 1.0 × 10³ |

### Example 3

Antibcterial Spray

Material and Methods

A part of a humid surface (a marble top near the sink in a public toilet) was treated with a spray solution of Comp.1 and sampled once every hour for 4 consecutive hours, for bacterial content by swab sampling and spreading on a Petri dish.

Results

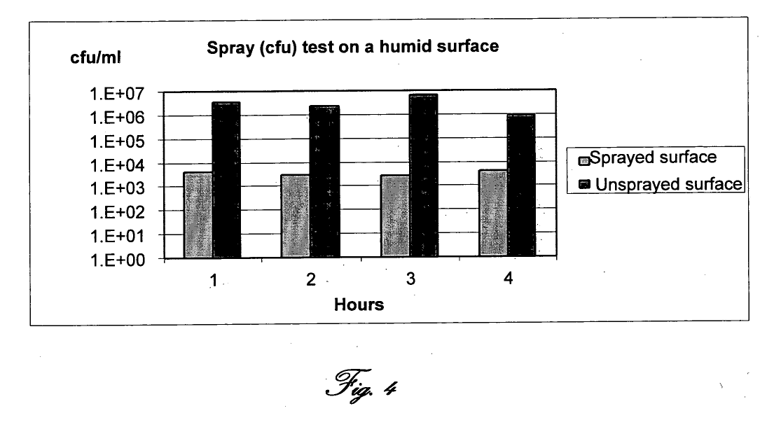

Reference in now made to FIG. 4, showing bacterial counts (CFU) in samples taken from sprayed and unsprayed marble surface.

Results in Table 2 and FIG. 4 below show a difference of 3-orders-of-magnitude in bacterial population between spray-treated and untreated marble surface.

TABLE 2
Bacterial counts (CFU) in samples taken
from sprayed and unsprayed marble surface

| Time after | Sprayed surface | Unsprayed surface |
|---|---|---|
| treatment (h) | (CFU) | (CFU) |
| 1 | 3.9 × 10³ | 3.5 × 10⁶ |
| 2 | 3.1 × 10³ | 2.4 × 10⁶ |
| 3 | 2.7 × 10³ | 6.8 × 10⁶ |
| 4 | 3.9 × 10³ | 9.2 × 10⁵ |

### Example 4

Carpet Treatment with Antibacterial Spray

Material and Methods

A carpet was wetted with Luria Broth medium and left on the table in room temperature. Half of carpet was sprayed with Comp 1 material and swab-sampled for bacterial counts at Time-0 (immediately after wetting) and 4 hrs later. Bacterial counts were carried out on TSA plats.

Results

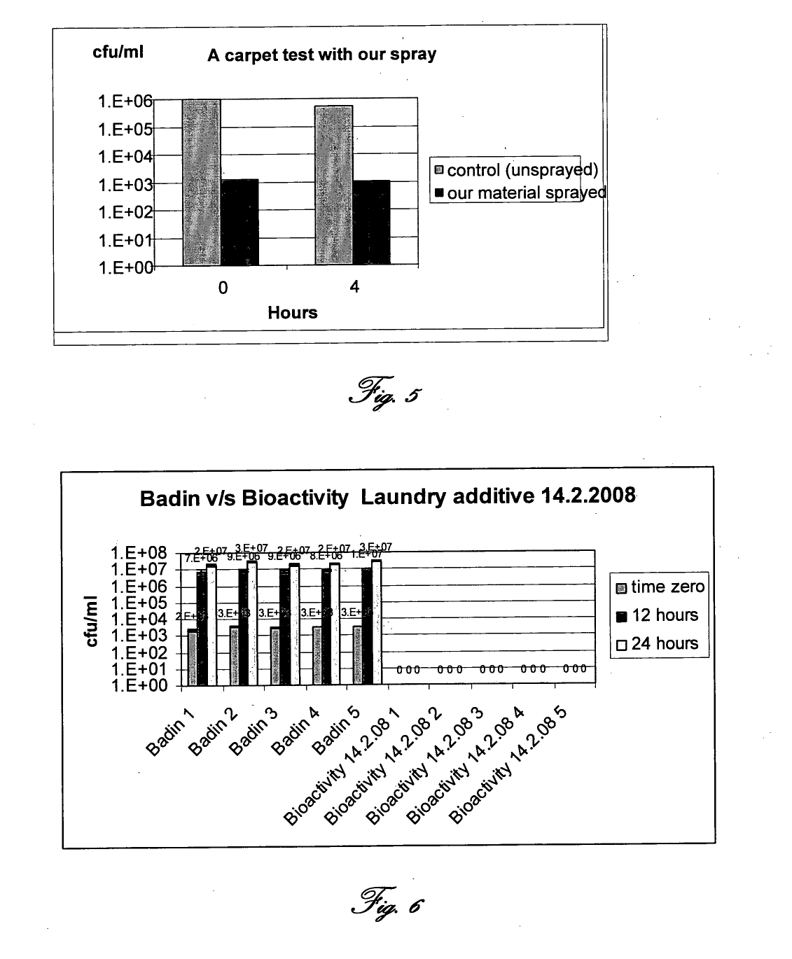

Reference is now made to FIG. 5, showing bacterial counts (CFU) in samples taken from Comp 1-sprayed and unsprayed carpet. Results in Table 3 and FIG. 5 show a difference of 3-orders-of-magnitude in bacterial population between spray-treated and untreated marble carpet.

TABLE 3
Bacterial counts (CFU) in samples taken
from Comp 1-sprayed and unsprayed carpet

| Time after treatment (h) | control (unsprayed) | Comp 1 sprayed carpet |
|---|---|---|
| 0 | 1 × 10⁶ | 1.3 × 10³ |
| 4 | 5.3 × 10⁵ | 1 × 10³ |

### Example 5

Laundry Additive

A laundry additive was composed by mixing the following ingredients: Amido Amine (Tianjin Angel Trading co ltd. China)—5%; Dipalmitoylethyl Hydroxyethylmonium Methosulfate (Stepan Co, Canada)—10%; Imidozolinium (Betapharma Co Ltd. Shanghai, China)—10%; Sodium Carbonate (Yuantongda Technology trade Co Ltd. China)—20%; Sodium Hydroxide (Sigma)—5%; Dowex M-31 Ion Exchange resin (Dow Chemicals)—4; Water—46%

Material and Method

15 cotton fabrics in size of 10 cm×10 cm were kept with laundry in tap water with TSB (ratio 1:10) that was open in air 24 hours. Cotton fabric was sampled for cfu measurement before wash (cfu rate of 2.E+07). The laundry was washed by washing machine (regular cycle in 5 liter washing machine, 30° C.), one test with 150 ml Badin laundry additive (Unilever, commercially available in Israel) and once with 150 ml Bioactivity laundry additive 14.2.08 100 ml of Mutag soap was added. Five cotton fabric were kept at time zero in freezer and the five kept after 12 h & 24 h in freezer after being in humid conditions at room temperature (30° C.), samples were weigh and according to it PBS was added to sterile tube with the small piece of cotton cloth (1 gr of cotton cloth with 10 ml PBS) The tube was shaken vigorously (vortex 1 min), diluted into decimal dilutions (bacterial samples 100 μl), seeded on TSA Petri dish (Hy-labs, Israel), incubated (30° C., 24 h) and counted.

Results

Reference is now made to FIG. 6; presenting the activity of commercially available laundry softener (Badin™) as compared a composition comprising PSS according to the present invention (i.e., Bioactivity™ laundry additive). Thus, laundry additive of the above listed composition shows great effect on laundry, it kills all bacteria.

1-35. (canceled)

36. A household cleaning material effective for killing cells, said household cleaning material comprising at least one charged polymer, said at least one charged polymer characterized, when in contact with a water-containing environment, as:
a. carrying strongly acid and/or strongly basic functional groups;
b. having a pH of less than about 4.5 or greater than about 8.0;
c. capable of generating an electrical potential within the confined volume of said cell sufficient to disrupt effectively the pH and/or electrical balance within said confined volume of said cell; and,
d. being in a form chosen from the group consisting of (i) H⁺ and (ii) OH⁻;
wherein said charged polymer is adapted to preserve the pH of said cell's environment.

37. The household cleaning material of claim 36, further characterized, when said groups are accessible to water, as having a buffering capacity of about 20 to about 100 mM H⁺/L/pH unit.

38. The household cleaning material of claim 36, further characterized, when said groups are accessible to water, by at least one characteristic chosen from the group consisting of (a) sufficiently water-insoluble such that at least 99.9% remains undissolved at equilibrium; (b) sufficiently resistant to leaching such that the total concentration of material leached from said composition of matter into said water-containing environment does not exceed 1 ppm; (c) sufficiently inert such that at least one parameter of said water-containing environment chosen from the group consisting of (i) concentration of at least one predetermined water-soluble substance; (ii) particle size distribution; (iii) rheology; (iv) toxicity; (v) color; (vi) taste; (vii) smell; and (viii) texture remains unaffected according to preset conditions, said conditions adapted for and appropriate to said particular environment.

39. The household cleaning material of claim 36, further comprising at least one polymer chosen from the group consisting of (a) polyvinyl alcohol; (b) polystyrene sulfonate; and (c) polypropylene polystyrene-divinylbenzene.

40. The household cleaning material of claim 39, wherein at said at least one polymer contains at least one functional group chosen from the group consisting of SO₃H and H₂N(CH₃).

41. The household cleaning material of claim 36, further comprising hydrophilic additives chosen from the group consisting of proton conductive materials (PCMs) and hydrophilic polymers (HPs); further wherein said PCMs and HPs are chosen from the group consisting of (a) sulfonated tetrafluoroethylene copolymers; (b) sulfonated materials chosen from the group consisting of silica, polythion-ether sulfone (SPTES), styrene-ethylene-butylene-styrene (S-SEBS), polyether-ether-ketone (PEEK), poly(arylene-ether-sulfone) (PSU), polyvinylidene fluoride (PVDF)-grafted styrene, polybenzimidazole (PBI), and polyphosphazene; and (c) proton-exchange membranes made by casting a polystyrene sulfonate (PSSnate) solution with suspended micron-sized particles of cross-linked PSSnate ion exchange resin.

42. The household cleaning material of claim 36, comprising two or more charged polymers chosen from the group consisting of two-dimensional charged polymers and three-dimensional (3D) charged polymers, each of which of said charged polymers comprises materials containing cationic and/or anionic groups capable of dissociation and spatially organized in a manner adapted to preserve the pH of said water-containing environment according to preset conditions; said spatial organization chosen from the group consisting of (a) interlacing; (b) overlapping; (c) conjugating; (d) homogeneously mixing; (e) heterogeneously mixing; and (f) tiling.

43. The household cleaning material of claim 36, further comprising a surface with a given functionality and at least one external proton-permeable layer, each of which of said at least one external proton-permeable layers is disposed on at least a portion of said surface.

44. The household cleaning material of claim 36, comprising at least one charged polymer and at least one barrier adapted to prevent heavy ion diffusion.

45. The household cleaning material of claim 36, wherein said household cleaning material is in the form of a continuous barrier, said barrier selected from the group consisting of (a) 2D pads; (b) 3D pads; (c) sponges; (d) nonwoven webs; (e) membranes; (f) filters; (g) meshes; (h) nets; (i) sheet-like members; (j) any combination of the above.

46. The household cleaning material of claim 36, wherein said household cleaning material is in the form of an insert of dimensions adapted to allow mounting within an article of manufacture of predetermined dimensions, said mounting chosen from the group consisting of reversible mounting and permanent accommodation.

47. The household cleaning material of claim 36, wherein said household cleaning material is in a form chosen from the group consisting of (a) powder; (b) gel; (c) suspension; (d) spray; (e) resin; (f) coating; (g) film; (h) sheet; (i) bead; (j) particle; (k) microparticle; (l) nanoparticle; (m) fiber; (n) thread.

48. The household cleaning material of claim 36, further characterized by at least one of the following:
a. capacity for absorbing or releasing protons capable of regeneration;
b. buffering capacity capable of regeneration; and
c. proton conductivity capable of regeneration.

49. A method for increasing the rate of death of living cells and/or decreasing the rate of reproduction of living cells within a water containing-environment, comprising the steps of:
a. providing a household cleaning material comprising at least one charged polymer, said at least one charged polymer characterized, when in contact with said water-containing environment, as:
i. carrying strongly acid and/or strongly basic functional groups;
ii. having a pH of less than about 4.5 or greater than about 8.0;
iii. capable of generating an electrical potential within the confined volume of said cell sufficient to disrupt effectively the pH homeostasis and/or electrical balance within said confined volume of said cell; and,
iv. being in a form chosen from the group consisting of (i) H⁺ and (ii) OH⁻; and,
b. placing said household cleaning material in contact with said water-containing environment.

50. The method of claim 49, wherein said step (a) further comprises the step of providing said charged polymer with predetermined water permeability, proton conductivity, and/or wetting characteristics, and further wherein said water permeability, proton conductivity, and/or wetting characteristics are provided by at least one substance selected from the group consisting of proton conductive materials (PCMs) and hydrophilic polymers (HPs).

51. The method of claim 50, wherein said step of providing said charged polymer with predetermined water permeability, proton conductivity, and/or wetting characteristics, and further wherein said water permeability, proton conductivity, and/or wetting characteristics are provided by at least one substance selected from the group consisting of proton conductive materials (PCMs) and hydrophilic polymers (HPs) further comprises a step of choosing said PCMs and HPs from the group consisting of (a) sulfonated tetrafluoroethylene copolymers; (b) sulfonated materials chosen from the group consisting of silica, polythion-ether sulfone (SPTES), styrene-ethylene-butylene-styrene (S-SEBS), polyether-ether-ketone (PEEK), poly(arylene-ether-sulfone) (PSU), polyvinylidene fluoride (PVDF)-grafted styrene, polybenzimidazole (PBI), and polyphosphazene; (c) proton-exchange membranes made by casting a polystyrene sulfonate (PSSnate) solution with suspended micron-sized particles of cross-linked PSSnate ion exchange resin; and derivatives thereof.

52. The method of claim 49, further comprising a step of providing at least one polymer chosen from the group consisting of (a) polyvinyl alcohol; (b) polystyrene sulfonate; and (c) polypropylene polystyrene-divinylbenzene.

53. The method of claim 52, wherein said step of providing at least one polymer further comprises a step of providing at least one polymer that contains at least one functional group chosen from the group consisting of SO₃H and H₂N(CH₃).

54. The method of claim 53, further comprising a step of providing two or more charged polymers chosen from the group consisting of two-dimensional charged polymers and three-dimensional (3D) charged polymers, each of which of said charged polymers comprises materials containing cationic and/or anionic groups capable of dissociation and spatially organized in a manner adapted to preserve the pH of said water-containing environment according to preset conditions; said spatial organization chosen from the group consisting of (a) interlacing; (b) overlapping; (c) conjugating; (d) homogeneously mixing; (e) heterogeneously mixing; and (f) tiling.

55. The method of claim 54, further comprising a step of spatially organizing each of said functional groups in a manner selected from (a) interlacing; (b) overlapping; (c) conjugating; (d) homogeneously mixing; (e) heterogeneously mixing; and (f) any combination of the above.

56. The method of claim 49, further comprising an additional step of providing said charged polymer with an ionomeric barrier layer comprising a sulfonated tetrafluoroethylene copolymer, said barrier adapted to avoid heavy ion diffusion.

57. A method of production of a household cleaning material effective for killing cells, comprising the steps of:
a. providing at least one charged polymer, said at least one charged polymer characterized, when in contact with said water-containing environment, as:
i. carrying strongly acid and/or strongly basic functional groups;
ii. having a pH of less than about 4.5 or greater than about 8.0;
iii. capable of generating an electrical potential within the confined volume of said cell sufficient to disrupt effectively the pH homeostasis and/or electrical balance within said confined volume of said cell; and,
iv. being in a form chosen from the group consisting of (i) H⁺ and (ii) OH⁻; and,
b. adapting said charged polymer to a form chosen from the group consisting of (a) powder; (b) gel; (c) suspension; (d) spray; (e) resin; (f) coating; (g) film; (h) sheet; (i) bead; (j) particle; (k) microparticle; (l) nanoparticle; (m) fiber; (n) thread; (o) cloth.

58. The method of claim 57, wherein said step of providing at least one electrolyte charged polymer characterized, when in contact with said water-containing environment, by at least one characteristic chosen from the group consisting of (a) sufficiently water-insoluble such that at least 99% remains undissolved at equilibrium; (b) sufficiently resistant to leaching such that the total concentration of material leached from said composition of matter into said water-containing environment does not exceed 1 ppm; (c) sufficiently inert such that at least one parameter of said water-containing environment chosen from the group consisting of (i) concentration of at least one predetermined water-soluble substance; (ii) particle size distribution; (iii) rheology; (iv) toxicity; (v) color; (vi) taste; (vii) smell; and (viii) texture remains unaffected according to preset conditions, said conditions adapted for and appropriate to said particular environment.

59. The method of claim 57, wherein said step of providing at least one electrolyte further comprises the step of providing a charged polymer characterized, when in contact with said water-containing environment, as being sufficiently inert such that the toxicity said water-containing environment as defined by at least one parameter chosen from the group consisting of (a) LD₅₀ and (b) ICT₅₀ remains unaffected according to preset conditions, said conditions adapted for and appropriate to said particular environment.

60. The method of claim 57, further comprising steps of:
c. providing at least one external proton-permeable surface with a predetermined functionality; and
d. layering at least a portion of said proton-permeable surface with at least one of said charged polymer.

61. The method of claim 57, wherein said step of providing at least one polymer further comprises a step of providing at least one polymer chosen from the group consisting of (a) polyvinyl alcohol; (b) polystyrene sulfonate; and (c) polypropylene polystyrene-divinylbenzene.

62. The method of claim 57, wherein said step of providing at least one polymer that contains at least one functional group chosen from the group consisting of SO₃H and H₂N(CH₃).

63. A method for regenerating the biocidic properties of a household cleaning material as defined in claim 36, said method comprising at least one step chosen from the group consisting of (a) regenerating said household cleaning material's proton absorbing and/or releasing capacity; (b) regenerating said household cleaning material's buffering capacity; and (c) regenerating the proton conductivity of said household cleaning material.
